(19) United States
(12) Patent Application Publication
(10) Pub. No.: US 2014/0199775 A1
(43) Pub. Date: Jul. 17, 2014

(54) DEVICE AND METHOD FOR MONITORING THE CONDITION OF SUBSEA PARTS, PARTICULARLY CABLE CONNECTORS

(71) Applicant: AKER SUBSEA LIMITED, MAIDENHEAD, Berkshire (GB)

(72) Inventor: Philip Michael Bagley, Aberdeenshire (GB)

(73) Assignee: AKER SUBSEA LIMITED, MAIDENHEAD, Berkshire (GB)

(21) Appl. No.: 14/237,379

(22) PCT Filed: May 14, 2013
(86) PCT No.: PCT/GB2013/000215

§ 371 Date: Feb. 6, 2014

(30) Foreign Application Priority Data
May 19, 2012 (GB) 1208986.8

(51) Int. Cl. G01N 17/04; G01N 31/22

(52) U.S. Cl. CPC G01N 17/04; G01N 31/221
USPC 436/163; 174/84 R; 29/857; 422/401

(57) ABSTRACT

A subsea monitoring device comprises a metal part (12) disposed in a polymeric sheath (11,14), and means (10) for providing a sensible indication of pH at an interface between the part and the sheath. The part may be the metal shell of a connector. When a cable (13) extends from the connector, adjacent the connector the cable would be covered by the polymeric sheath. The said means (10) may comprise a chemical indicator and the sheath is preferably sufficiently translucent to allow visual observation of the indicator. The chemical indicator may comprise phenolphthalein.

This invention relates to the monitoring of the condition of subsea metal parts such as cable connectors and in particular to providing a warning of the incidence of de-lamination of polymeric sheaths for such parts.

### BACKGROUND TO THE INVENTION

In seawater metal corrosion occurs because of the generation of a corrosion cell. Steel and many other metals are not electrochemically stable in seawater and hence would corrode without preventative measures. Therefore, most metals used in seawater are coupled to a sacrificial anode. Galvanic corrosion will cause the more active metal (the sacrificial anode) to dissolve. In a corrosion cell the cathode does not dissolve, thereby protecting the metal of importance. However, protecting subsea infrastructure in this way can cause cathodic delamination of subsea cables, and it is recognised as the major cause of subsea cable failure.

### SUMMARY OF THE INVENTION

The invention recognises the possibility of monitoring a subsea part by means of monitoring the local pH at an interface between a metal part, such as the metal shell of a connector, and its protective polymeric sheath. In its preferred form the invention provides a device which can provide such monitoring for very long periods of time.

In one form the invention provides a subsea device comprising a metal part disposed in a polymeric sheath, and including means for providing a sensible indication of pH at an interface between the part and the sheath.

The part may be the metal shell of a connector. The term ‘connector’ is intended to mean any form of connector for a cable to a subsea housing or other structure, whether releasable or non-releasable, whether making external connection or internal connection (as in the example of a ‘penetrator’). When a cable extends from the connector, the cable adjacent the connector would be covered by the polymeric sheath. The said means may comprise a chemical indicator and the sheath is preferably sufficiently translucent to allow visual observation of the indicator. The chemical indicator may comprise phenolphthalein.

The invention also provides a method of making a pH indicator for a subsea connector which has a metal shell, comprising:
(i) disposing a heat-shrinkable translucent sleeve over the shell;
(ii) shrinking one end of the sleeve onto the shell to form a receptacle between the sleeve and the shell;
(iii) partially filling the receptacle with a solution of a chemical indicator;
(iv) heat-shrinking the other end of the sleeve to seal the indicator within the sleeve; and
(v) attaching a cable to the connector.

The method preferably further comprises moulding a translucent polymeric sheath over the sleeve and the cable adjacent the connector.

### BRIEF SUMMARY OF THE DRAWINGS

FIG. 1 is a an explanatory diagram illustrating a sacrificial cell;

FIGS. 2 to 4 illustrate the stages of cathodic delamination;

FIGS. 5A and 5B illustrate schematically the operation of the invention;

FIG. 6 illustrates one embodiment of the invention; and

FIGS. 7A to 7F illustrate one method of manufacturing an embodiment of the invention.

### DETAILED DESCRIPTION

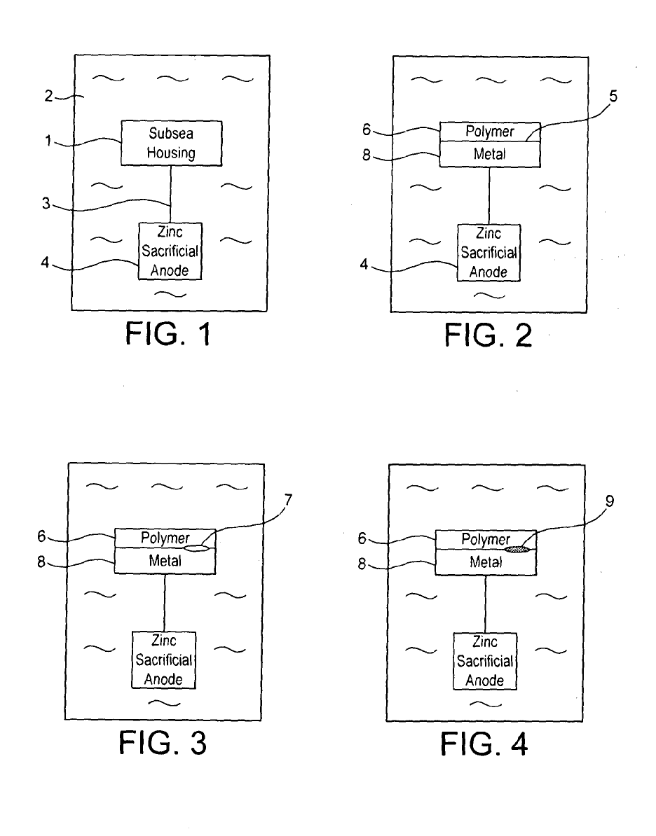

As previously mentioned, in seawater metal corrosion occurs because of the generation of a corrosion cell. FIG. 1 illustrates schematically a typical sacrificial corrosion cell. A subsea structure such as a housing 1, which acts as a cathode, is immersed in an electrolyte (seawater) 2 and is directly connected by some electrically conductive path 3 to a sacrificial anode 4, which is typically composed of zinc. Galvanic corrosion will cause the more active metal (the sacrificial anode) to dissolve. In a corrosion cell such as shown in. FIG. 1 the cathode 1 does not dissolve, so that the structure is protected against corrosion. However, protecting subsea infrastructure in this way can cause what is known as cathodic delamination, which is recognised to be a major cause of failure of subsea cables.

FIGS. 2 to 4 illustrates various stages in the onset of cathodic delamination of a subsea cable. In subsea cabling a metal connector 8 is usually protected from seawater by over-moulding the connector with a water resistant polymeric sheath 6 as shown in FIG. 2. The metal connector 8 is connected to a sacrificial anode 4.

At the interface between the anode 4 and seawater 2 the metal (zinc) ionises:

Zn→Zn⁺⁺+2e−

At an interface 5 between the metal 8 of the connector and the moulding 6, as the polymer moulding 6 becomes saturated with seawater and dissolved oxygen, there occurs the formation of hydroxide ions by virtue of the reaction:

2H₂O+O₂+4e⁻→4OH⁻

The reaction produces a very high pH (alkaline) at a region 7 of the interface between the cathodically polarised surface and the material directly connected to it, as shown in FIG. 3. The high pH at the metal/polymer interface generates high osmotic pressure, resulting in water blistering 9 at the interface and ultimate delamination of the polymer 6 from the metal 8 and subsequent cable failure (FIG. 4). For this reaction to occur the polymer must be saturated with water and oxygen. All polymers are porous to some extent and eventually there will be sufficient water and oxygen content in the polymer to produce cathodic delamination.

As a pH change at the interface between the polymer and the metal part is a precursor of the blistering, a pH indicator at the metal polymer interface should give an early indication of cable delamination before any delamination occurs. Importantly, the pH change is significant (highly alkaline) and it is therefore feasible to detect the change by means of a chemical indicator.

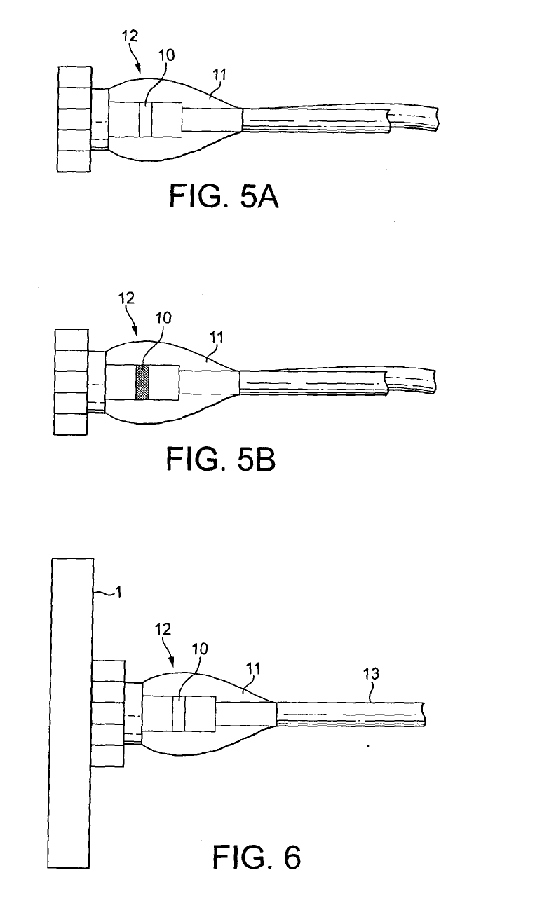

One example is shown in FIGS. 5A and 56. A layer 10 of a pH indicator is disposed at the interface between the metal part of a cable connector 12 and a polymeric over-mould 11. This indicator is intended to provide a visual indication, i.e. a colour change as shown in FIG. 5B, and accordingly the construction of the over-moulding has to take account of the requirement for visibility of the pH indicator. Hence, around the region of the pH indicator the over-moulding polymer should be transparent or at least sufficiently translucent so that the indicator may be visually inspected at appropriate intervals.

A pH indicator used as described needs to be stable for a long time, typically at least several years. Phenolphthalein is a standard solution used for pH indication. It remains clear at pH levels from pH 1 (highly acidic) to (approximately) pH 9 (alkaline), where it turns red or pink to pH 14 (highly alkaline). The powdered form of phenolphthalein is highly stable and has no specified shelf life. For use as a pH indicator phenolphthalein may be mixed with ethanol. The stability of this indicator solution is dependent on the concentration of the solution which changes over time due to evaporation or other loss of the alcohol. In this subsea context, a phenolphthalein solution may be contained in an air-tight and water-tight moulding inhibiting the loss of alcohol and therefore preserving the stability of the indicator solution.

The invention is not confined to the use of phenolphthalein. Other possible chemical indicators include thymol blue, congo red, methyl red , methyl orange, azolitmin, phenol red and so on.

FIG. 6 illustrates one embodiment for providing a cable condition monitoring mechanism in a typical subsea context. A subsea cable 13 such as an umbilical is provided with a terminal metal connector 12 which may make external or internal connection with a subsea structure 1 such as a manifold or tree. A transparent over-moulded sheath 11 surrounds the connector and a pH sensor 10 constituted by a phenolphthalein-based indicator is disposed at the interface between the outside of the connector and the sheath.

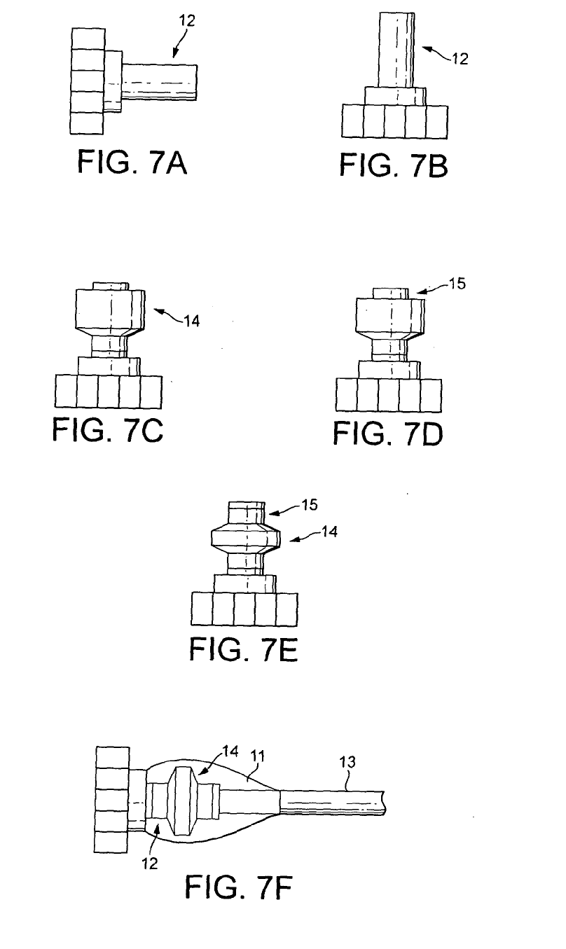

FIGS. 7A to 7F illustrate schematically one method of manufacturing a pH sensing apparatus according to the invention.

FIG. 7A shows a metal connector 12 before over-moulding. It is put into an upright state (FIG. 7B) and one end (the lower end) of a transparent heat-shrinkable sleeve 14 is shrunk onto the metal body or shell of the connector, the other end being left temporarily unshrunk, as shown in FIG. 7C. The sleeve may be commercially available polyolefin tubing. This action forms a well-shaped space 15 which is partially filled with a solution of phenolphthalein in alcohol (FIG. 7D). Then the open (upper) end 16 of the heat-shrinkable sleeve 14 is shrunk onto the connector (FIG. 7E) to seal the indicator solution in contact with the metal connector. A cable 13 is connected to the connector and a transparent cover 11 is over-moulded on the connector 12, extending some suitable distance from the connector along the outside of the cable, as shown in FIG. 7F, so that at least the part of the cable 13 adjacent the connector 12 is covered by the sheath comprising the sleeve 14 and the moulded cover 11. The cover 11 may be a suitable commercial available polymeric material such as an optically clear polyurethane encapsulant.

The chemical pH sensor described will change colour to red or pink to warn of a pending cathodic delamination failure. Therefore, the connector with the embedded indicator must be visually observed at regular intervals. This observation can be included in a routine survey of subsea structures by a ROV (or by a diver in shallow water). Alternatively it may be observed by a camera or CCTV.

Other chemical indicators might be used instead of the phenolphthalein-based indicator described above, provided that they are sufficiently stable for the long periods of use that may be required.

Furthermore it is feasible to employ an electronic pH sensor to provide an electrically sensible indication of pH at the metal-sheath interface instead of a visually sensible indication required for a chemical indicator. Power and communication for this electronic sensor could be provided via spare pins on the connector. Such a sensor would not require visual monitoring. However, en electronic sensor is not at present preferred because commercial available electronic sensors are not proven to have the ability to remain stable for a long time (at least several years).

1. A subsea device comprising a metal part disposed in a polymeric sheath, characterised by means for providing a sensible indication of highly alkaline pH at an interface between the part and the sheath.

2. A device according to claim 1 in which the part is a metal shell of a subsea cable connector.

3. A device according to claim 2 in which a cable extends from the connector and adjacent the connector is covered by the polymeric sheath.

4. A device according to claim 1 in which the said means comprises a chemical indicator and the sheath is sufficiently translucent to allow visual observation of the indicator.

5. A device according to claim 4 in which the chemical indicator comprises phenolphthalein.

6. A device according to claim 4 in which the sheath comprises a heat-shrunk sleeve and a moulded cover.

7. A method of monitoring the condition of a subsea part which has a protective polymeric sheath over a metal shell, comprising monitoring for the occurrence of highly alkaline pH at an interface between the shell and the sheath so as to provide a warning of delamination of the sheath.

8. A method of making a pH indicator for a subsea cable connector which has a metal shell, comprising:
(i) disposing a heat-shrinkable translucent sleeve over the shell;
(ii) shrinking one end of the sleeve onto the shell to form a receptacle between the sleeve and the shell;
(iii) partially filling the receptacle with a solution of a chemical indicator;
(iv) heat-shrinking the other end of the sleeve to seal the indicator within the sleeve; and
(v) attaching a cable to the connector.

9. A method according to claim 8 and further comprising moulding a translucent polymeric cover over the sleeve and the cable adjacent the connector.
